(19) United States
(12) Patent Application Publication
(10) Pub. No.: US 2007/0134282 A1
(43) Pub. Date: Jun. 14, 2007

(54) Methods for inhibiting fungal pathogen infestation and propogation

(75) Inventors: Shiyou Li, Nacogdoches, TX (US); Zhizhen Zhang, Houston, TX (US)

Correspondence Address: COX SMITH MATTHEWS INCORPORATED, 112 EAST PECAN STREET, SUITE 1800, SAN ANTONIO, TX, 78205-1521, US

(73) Assignee: Stephen F. Austin State University, Nacogdoches, TX (US)

(21) Appl. No.: 11/299,280

(22) Filed: Dec. 9, 2005

(51) Int. Cl. A01N 65/00; A01N 25/00; A01N 43/42; A01N 35/00

(52) U.S. Cl. 424/405; 514/283; 514/680; 424/725

(57) ABSTRACT

The use of camptothecin (CPT), hyperoside and/or trifolin in preventing or inhibiting the growth of fungal pathogens, including molds.

### BACKGROUND OF THE INVENTION

1. Field of The Invention

Applicant's invention generally relates to the field of plant pathology. Specifically, the proposed invention includes compositions, processes for their production, and methods for their use in controlling certain plant fungal pathogens, including molds.

2. Background Information

a. Fungal Infestation

Fungal infestations (largely of the subset of “molds”) in the plant realm come in a wide variety of forms and they, as well as, in some cases, the conventional measures to combat them, extract an enormous toll, economically, aesthetically and environmentally.

The mold subset of fungus share the characteristics of forming a mycelium, but lacking a sporocarp. Mold spores are ubiquitious, germinate quickly and often quickly substrates rapidly.

In the food realm, (e.g., bread, cheese, peaches) or manufactured goods of organic origin, molds represent an often serious health hazard. By way of example, Alternaria, Epicoccum, Drechslera, and Fusarium are all objects of allergies (sometimes life-threatening allergies) in many humans.

Agricultural, horticultural and forest plants are also threatened by fungal pathogens native to the United States as well as invasive fungi from other countries. Thus, the export of agricultural crops from the United States to other countries is sometimes influenced by the presence/absence of fungi of importance in relation to plant quarantine regulations.

According to the 2003 report of the Agricultural Research Service of the U.S. Department of Agriculture, economic loss to agricultural and horticultural crops from disease-causing fungi is estimated at $20 billion per year in the United States. In addition, fungi often limit U.S. agricultural exports, a significant negative factor for the U.S. in the over-all balance of trade.

Currently available, broad-spectrum fungicides are mostly synthetic, and are of limited efficacy and/or are environmentally pernicious, e.g., chlorothalonil (Daconil Ultrex, Daconil Zn, Daconil Weather Stik—use of these products on home lawns is prohibited), iprodione (Chipco 26019—prohibited at residential sites), mancozeb (Fore), maneb, fixed coppers and zineb. The most effective fungicide applications may provide only a 50-60% reduction in the above-described diseases. Ironically, application of some major herbicides even increased the presence of Fusarium in crops.

Among the fungal disease categories of paramount concern to society is that known as “leaf spot.” Leaf spot is a common descriptive term applied to a number of widespread and destructive fungal diseases which affect virtually all commonly grown trees and shrubs. Plant varieties differ in their susceptibility to leaf spot, but the primary symptom of a leaf spot disease typically comes as brown spots on foliage.

Leaf spot diseases are caused by a variety of fungal pathogens which can survive from year to year as spores or mycelium (fungal threads) in dead plant debris, in the thatch layer, and in infected plant parts. Once into the leaf, the fungi continue to grow and leaf tissue is destroyed. Spots tend to grow and multiply to the point that they merge to become a “blight” or a “blotch.” Partial to complete defoliation of the plant may occur under conditions which are favorable for the causal fungus.

If to be even partly effective, presently available fungicides must be applied as a protectant before the fungus spore is disseminated to the leaf. Optimal, though incomplete control of fungal infestations through use of conventional fungicides usually requires two to three spray applications, with additional applications typically showing nominal, if any greater efficacy, and/or effecting one or more undesirable side effects in the plants or surrounding environment which outweigh any advantages of further use.

Root rot is another product of fungal infestation and, like leaf spot, arises from several different species of fungus that are common to field soil, sand, pond and stream water and their sediments, as well as in dead roots of previous crops. Root rot is typically fatal for the infected plants, with earlier symptoms including wilting, yellowing and retention of dried foliage and darkening of young feeder roots and occasionally the larger roots. Root rot is difficult to control once it has begun.

Of particular note in the root rot context is Fusarium, which is a genus of fungi and a well-known plant pathogen. Fusarium wilt affects many different horticultural plants and is the most important pathological problem of plants grown in artificial growing media. Fusarium is a filamentous fungus that is widely distributed on plants and in the soil. Several different species of Fusarium (including F. oxysporum, F. solani, and F. avenaceum) can cause root rot of, among other things, container tree seedlings.

Fusarium root rot is one of the most common diseases of seedlings in the world and is widespread in North American nurseries. Most conifer seedlings, including spruces, true firs, pines and larch are susceptible to Fusarium root rot. Fungicidal drenches are commonly used in attempts to control Fusarium root rot, but these treatments function primarily to impede the spread of the infestation, and rarely are there any indications of an actual reversal of an existing infestation.

b. Camptotheca acuminata and camptothecin (CPT).

Camptotheca acuminata is a member of the family Nyssaceae (tupelo family). This fast-growing, deciduous tree is native only to China and Tibet. This tree (along with some alternative sources to be discussed below) is a source for a potent anti-leukemia and anti-tumor ingredient—a quinoline alkaloid called camptothecin (CPT). CPT has been modified to create many other anti-cancer drugs, including irinotecan, topotecan, 9-aminocamptothecin, and CPT-11.

CPT and these analogs are being investigated to treat a wide variety of cancers, but the compounds are quite toxic. Only topotecan (Hycamtin®) and irinotecan HCl (Camptosar®) have met with FDA approval; Hycamtine® has been approved for ovarian cancer therapy, and Camptosar® is approved for metastatic colorectal cancers.

Leaf spots caused by Alternaria, Epicoccum, and Pestalotia, as well as root rots caused by Fusarium, are major fungal diseases affecting biomass and CPT production in Camptotheca cultivation.

Leaf spots often increase in severity as the growing season progresses and leaves become mature. Leaves die and drop off prematurely, and the all-important CPT yields are decreased as a result of the diseased plant's decreased ability to carry out photosynthesis.

Contributing fungal factors in leaf spot in Camptotheca include E. nigrum. E. nigrum is a cosmopolitan saprophyte found on many plants, textiles, paper products, and foodstuff, in soils and air samples. P. guepinii is primarily a secondary pathogen. It is saprophytic on dead and dying tissues and is weakly parasitic, infecting through wounds under moist conditions. Drechslera spp. are either plant pathogens or saprobes. Fusarium, as previously mentioned, is a soil borne fungus with worldwide distribution, particularly throughout tropical and subtropical areas.

c. Present Anti-fungal Research and Conventional Anti-fungal Measures.

Dithiocarbamates are organic fungicides commonly used for the treatment of soil, seeds, and foliar and postharvest diseases of some crops. Dithiocarbamates, including Maneb, N,N-diethyldithiocarbamic acid sodium salt, and some newly synthetic compounds, are shown to inhibit growth of F. oxysporum f. sp. lini, but only by 7-30% at the concentration of 100 ppm (100 μg/mL).

As the most potent antifungal compound of the essential oils of 13 herbs selected by Sridhar et al. (2003), geraniol isolated from cymbopogan (Cymbopogan martini) inhibited growth of Botrytis cinerea in both in vitro tests and TLC bioautography with a minimum concentration of 160 μg/mL (MIC). Essential oils of Salvia sclarea L. (Lamiaceae) inhibited growth of F. oxysporum f. sp. dianthi by 72% at concentrations of 2,000 μL/L. β-Asarone from rhizomes of Acorus gramineus Solander (Araceae) was effective against mycelial growth of Alternaria mali (with MIC>100 μg/mL) and F. oxysporum f.sp. lycopersici (with MIC>100 μg/mL). Vanillin, 4-hydroxy-3-methoxycinnamaldehyde, and (±) pinoresinol isolated from Melia azedarach L. (Meliaceae) controlled F. verticillioides at higher concentrations (with MICs of 600, 400, and 1,000 μg/mL, respectively).

Despite the limited efficacy of the above-described anti-fungal agents, and in particular view of the dramatic increase, in recent times, in pathogen resistance to both agrochemical and pharmaceutical fungicides, discovery of new antimicrobial compounds with new modes of action is becoming increasingly important. No presently-available fungicide is particularly effective against leaf spots and root rots.

In view of the above, there exists a dire need for, not only composition(s) with effective, broad spectrum anti-fungal properties, but ones which are, to the greatest degree possible, environmentally benign. Also needed are method(s) to economically produce such agents or compositions.

### SUMMARY OF THE INVENTION

It is an object of the present invention to provide compositions for controlling plant fungal pathogens.

It is an object of the present invention to provide compositions for more effectively controlling plant fungal pathogens than is possible through use of presently available compositions or methods.

It is another object of the present invention to provide compositions for controlling plant fungal pathogens, which compositions are more environmentally benign than presently-available compositions of similar intended use.

It is another object of the present invention to provide a method for producing compositions for controlling plant fungal pathogens.

It is another object of the present invention to provide a method for producing compositions for more effectively controlling plant fungal pathogens than is possible through use of presently available compositions or methods.

It is another object of the present invention to provide a method for producing compositions for controlling plant fungal pathogens, which compositions are more environmentally benign than presently-available compositions of similar intended use.

It is another object of the present invention to provide a method for controlling plant fungal pathogens more effective than is possible through use of presently available compositions or methods.

It is another object of the present invention to provide a method for controlling plant fungal pathogens, which compositions are more environmentally benign than are presently-available compositions of similar intended use.

It is another object of the present invention to provide a method for controlling plant fungal pathogens more cost-effective than is possible through use of presently available compositions or methods.

In satisfaction of these and related objectives, Applicant's present invention provides compositions, methods for producing compositions, and method of use of such compositions which collectively satisfy all of the above objects, and individually meet at least a subset of such objects.

The present invention relates to camptothecin (CPT) and the flavonoids trifolin and hyperoside, all isolated from plants known to contain same. All experimental data to-data arises extraction from Camptotheca., however, the following plant species are presently also known to contain CPT, and extraction from such plants (methods for which are within the scope of knowledge of persons reasonably skilled in chemical extraction methodologies) will also fall within the scope of the present invention:
A. Camptotheca (Nyssaceae); including: Camptotheca acuminata Decaisne, Camptotheca acuminata var. tenuifolia Fang et Song, Camptotheca acuminata var. rotundifolia Yang et Duan, Camptotheca yunnanensis Dode, Camptotheca lowreyana Li, Camptotheca lowreyana Li ‘Katie’, Camptotheca lowreyana Li ‘Hicksii’
B. Ervatamia (Apocynaceae);
C. Nothapodytes (Mappia) (Olacaceae);
D. Ophiorrhiza (Rubiaceae);
E. Merrilliodendron (Icacinaceae);
F. Mostuea (Loganiaceae);
G. Pyrenacantha (Icacinaceae).

CPT, trifolin and hyperoside all exhibit unprecedented control over plant fungal pathogens in a cost-effective and environmentally-safe way, and the present inventors believe that analogues thereof would perform likewise.

CPT, trifolin, and hyperoside definitely and remarkably exhibit antifungal activity in Camptotheca plants. In fact, CPT affects cell growth of almost all organisms because it is a potent inhibitor of DNA topoisomerase.

As compared with the above-mentioned N,N-diethyldithiocarbamic acid sodium salt (which showed only a 7-30% fungal growth inhibition, at the same concentrations), for example, CPT, trifolin, and hyperoside inhibited growth of the related fungal pathogen F. avenaceum by 70% in vitro.

The present inventors have effected a CPT-induced, 50% inhibition of mycelial growth (EC₅₀) at relatively low concentrations: approximately 10 μg/mL for E. nigrum, P. guepinii, and Drechslera sp., <25 μg/mL for A. alternata, and <30 μg/mL for F. avenaceum (Table 2). Higher levels of CPT more effectively inhibited mycelial growth, but the minimal inhibitory concentration varied between the fungi: 75 μg/mL for A. alternata and E. nigrum, 100 μg/mL for Drechslera sp., 125 μg/mL for P. guepinii and F. avenaceum.

The flavonoids were less effective than the alkaloid CPT at the level of 50 μg/mL, particularly during the first three weeks of experimentation, but more effective than the alkaloid at the level of 100 or 150 μg/mL during the whole experimental period.

CPT, trifolin and hyperoside were, at all experimental concentrations, highly effective in inhibiting Drechslera sp. and F. avenaceum, and at relatively higher concentrations, CPT was effective in suppressing growth of A. alternata and E. nigrum.

Over-all, the present inventors have effectively produced, through use of CPT, trifolin, and hyperoside, a higher efficacy in combating fungal growth and viability than many recently discovered and, prior to the present invention, the most highly efficacious antifungal agents.

The present inventors find that CPTs, potent inhibitors of the enzyme DNA Topoisomerase I, has not been previously recognized in fungicide development.

Trifolin and hyperoside are abundant in Camptotheca and some other plants. Although their mechanisms of action against fungi are unclear, their effectiveness, availability, low cost, and probable low toxicity to humans make the flavonoids effective fungicides.

To date, commercial CPT synthesis is not feasible, and supplies of CPT required for the manufacture of the drugs are now extracted from the fruits of Camptotheca acuminata Decaisne, which has been listed as an endangered species in China since 1997.

Cultivation of the tree in the U.S. is limited because it grows in subtropical climates. Moreover, the tree takes approximately 10 years to produce a stable fruit yield. Fungal diseases, particularly leaf spot and root rots, are a main limiting factor in the cultivation of Camptotheca in plantations for vegetative biomass and CPT production.

On the other hand, potential demands of trifolin and hyperoside can be easily met because the source plants are commonly available—even from banana, hawthorns, and oaks.

### BRIEF DESCRIPTION OF THE DRAWINGS

FIG. 1 shows the structure of the alkaloid camptothecin (CPT) and the flavonoids, namely, trifolin and hyperoside, isolated from Camptotheca acuminata.

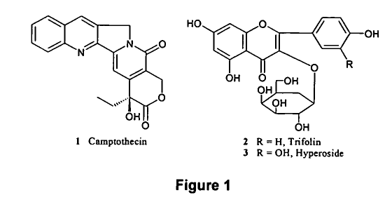

FIG. 2 is a graph illustrating the effect of different concentrations of camptothecin (CPT) and fungicides Bravo and Maneb on mycelial growth of Alternaria alternata. Concentrations of CPT: 10 μg/mL (CPT-10), 25 μg/mL (CPT-25), 50 μg/mL (CPT-50), 75 μg/mL (CPT-75), 100 μg/mL (CPT-100), 125 μg/mL (CPT-125), and 150 μg/mL (CPT-150); Concentration of Bravo: 10,000 μg/mL (Bravo); Concentration of Maneb: 3,000 μg/mL (Maneb). Points and bars represent the means and standard errors of five replicates.

FIG. 3 is a graph illustrating the effect of different concentrations of camptothecin (CPT) and fungicides Bravo and Maneb on mycelial growth of Epicoccum nigrum. Concentrations of CPT: 10 μg/mL (CPT-10), 25 μg/mL (CPT-25), 50 μg/mL (CPT-50), 75 μg/mL (CPT-75), 100 μg/mL (CPT-100), 125 μg/mL (CPT-125), and 150 μg/mL (CPT-150); Concentration of Bravo: 10,000 μg/mL (Bravo); Concentration of Maneb: 3,000 μg/mL (Maneb). Points and bars represent the means and standard errors of five replicates.

FIG. 4 is a graph illustrating the effect of different concentrations of camptothecin (CPT), trifolin, and hyperoside and fungicides Bravo and Maneb on mycelial growth of Pestalotia quepinii. Concentrations of CPT: 10 μg/mL (CPT-10), 30 μg/mL (CPT-30), 50 μg/mL (CPT-50), 70 μg/mL (CPT-70), 100 μg/mL (CPT-100), 125 μg/mL (CPT-125), and 150 μg/mL (CPT-150); Concentrations of Trifolin: 50 μg/mL (Trifolin-50), 100 μg/mL (Trifolin-100), and 150 μg/mL (Trifolin-150); Concentrations of Hyperoside: 50 μg/mL (Hyperoside-50), 100 μg/mL (Hyperoside-100), and 150 μg/mL (Hyperoside-150); Concentration of Bravo: 10,000 μg/mL (Bravo); Concentration of Maneb: 3,000 μg/mL (Maneb). Points and bars represent the means and standard errors of five replicates.

FIG. 5 is a graph illustrating the effect of different concentrations of camptothecin (CPT), trifolin, and hyperoside and fungicides Bravo and Maneb on mycelial growth of Drechslera sp. Concentrations of CPT: 10 μg/mL (CPT-10), 30 μg/mL (CPT-30), 50 μg/mL (CPT-50), 70 μg/mL (CPT-70), 100 μg/mL (CPT-100), 125 μg/mL (CPT-125), and 150 μg/mL (CPT-150); Concentrations of Trifolin: 50 μg/mL (Trifolin-50), 100 μg/mL (Trifolin-100), and 150 μg/mL (Trifolin-150); Concentrations of Hyperoside: 50 μg/mL (Hyperoside-50), 100 μg/mL (Hyperoside-100), and 150 μg/mL (Hyperoside-150); Concentration of Bravo: 10,000 μg/mL (Bravo); Concentration of Maneb: 3,000 μg/mL (Maneb). Points and bars represent the means and standard errors of five replicates.

FIG. 6 is a graph illustrating the effect of different concentrations of CPT, trifolin, and hyperoside fungicides Bravo and Maneb on mycelial growth of Fusarium avenaceum. Concentrations of CPT: 10 μg/mL (CPT-10), 30 μg/mL (CPT-30), 50 μg/mL (CPT-50), 70 μg/mL (CPT-70), 100 μg/mL (CPT-100), 125 μg/mL (CPT-125), and 150 μg/mL (CPT-150); Concentrations of Trifolin: 50 μg/mL (Trifolin-50), 100 μg/mL (Trifolin-100), and 150 μg/mL (Trifolin-150); Concentrations of Hyperoside: 50 μg/mL (Hyperoside-50), 100 μg/mL (Hyperoside-100), and 150 μg/mL (Hyperoside-150); Concentration of Bravo: 10,000 μg/mL (Bravo); Concentration of Maneb: 3,000 μg/mL (Maneb). Points and bars represent the means and standard errors of five replicates.

FIG. 7 is a graph illustrating the CPT concentrations of different tissues at different ages in Camptotheca acuminata.

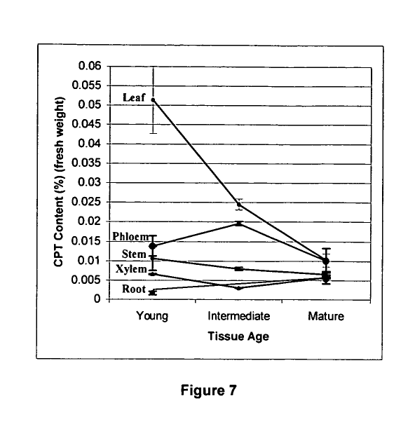

FIG. 8 is a table illustrating the experimental concentrations of three compounds (CPT, trifolin, and hyperoside) isolated from Camptotheca leaves for in vitro tests against five fungi isolated from Camptotheca acuminata.

FIG. 9 is a table illustrating the inhibition of alkaloid and flavonoids isolated from Camptotheca against mycelial growth of fungi. Note: Both EC₅₀ (effective concentration that caused 50% inhibition of mycelial growth) and MIC (the minimum inhibitory concentration) are the average of five replicates measured when the fungus completely covered the agar surface under control conditions.

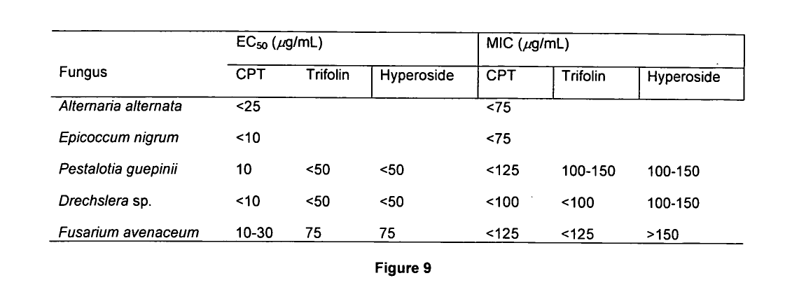

### DETAILED DESCRIPTION OF THE PREFERRED EMBODIMENT

The present invention will be described in relation to plant pathology, but may also have medical applications and be extended to use in the food industry.

The present inventors have effected unprecedented antifungal activity through use of CPT, trifolin, and hyperoside. Tests were conducted against five recently isolated fungi (molds) from C. acuminata.

A. Extraction Procedures.

Melting points were measured with a MEL-TEMP capillary melting point apparatus and were uncorrected. Optical rotations were determined on a JASCO DIP-370 digital polarimeter. UV and IR were recorded on a Hewlett-Packard 8435 spectrometer and an ATI Mattson Genesis Series FTIR spectrometer, respectively. NMR experiments were performed on a Varian Unity Plus 600 MHz spectrometer and NMR data are reported as δ (ppm) value, referenced to DMSO-d6. Silica gel (70-723 mesh, 60Å, Aldrich) and RP Silica gel (RP-18, Aldrich) were used for low-pressure chromatography. TLC was performed on silica gel 60 F254 (Aldrich) using CHCl3/MeOH (9:1, solvent A and 4:1, solvent B), or reversed-phase C18 silica gel (Aldrich) using MeOH/H2O (70:30, solvent C and 30:70, solvent D).

Leaves of C. acuminata were collected, and air-dried young leaf material (1000 g) was ground to a coarse powder and percolated with 95% EtOH five times. Removal of the solvent under a vacuum at 60° C. yielded 50 g EtOH extract. The EtOH extract was dissolved in MeOH/H2O (9:1, 500 mL) and then partitioned successively with hexane (500 mL×5) and CHCl3 (500 mL×5) to produce a hexane extract (20.1 g), a CHCl3 extract (18.5 g), and a MeOH/H2O extract (12.1 g). Part of the CHCl3 extract (8.0 g) was fractionated on a silica gel column (300 g) using CHCl3/EtOAc (9:1 and 4:1, each 500 mL) and then CHCl3/MeOH (9:1, 4:1, and 2:1, each 500 mL) to afford 50 fractions (each 50 mL), which were combined to six fractions of A (30 mg, 200-300 mL), B (18 mg, 800-900 mL), C (30 mg, 950-1050 mL), D (230 mg, 1150-1250 mL), E (16 mg, 1350-1450 mL), and F (6.7 g, 2100-2350 mL) on the basis of their TLC profiles. Compound 1 (200 mg) was precipitated from fraction D. Part of fraction F (2.0 g) was refractionated on a silica gel column (200 g) using CHCl3/MeOH (9:1, 4:1, and 2:1, each 700 mL) to afford 40 fractions (each 50 mL). Compounds 2 (301 mg) and 3 (280 mg) were precipitated from fractions 24-26 (1150-1300 mL) and fractions 29-30 (1400-1500 mL), respectively.

Camptothecin (4(S)-4-ethyl-4-hydroxy-1H-pyrano-(3′,4′:6,7) indolizino (1,2,-b) quinoline-3,14 (4H,12H)-dione) (Compound 1) was obtained as a yellowish amorphous solid: m.p. 265-266° C. (CHCl3); [α]D25-56.5° (c 0.1, DMSO); Rf 0.72 (silica gel, solvent A) and 0.63 (reversed-phase C18 silica gel, solvent C); UV (EtOH) λmax (log ε) 218 (4.38), 262 (4.13), 330 (2.87), 370 (3.98), 380 (4.05) nm; IR νmax (KBr) 3201, 1756, 1663, 1596 cm−1; 1H NMR (DMSO-d6, 600 MHz) δ 8.69 (1H, s, H-7), 8.16 (1H, d, J=7.8 Hz, H-12), 8.11 (1H, d, J=7.8 Hz, H-9), 7.86 (1H, t, J=7.8 Hz, H-11), 7.70 (1H, t, J=7.8 Hz, H-10), 7.37 (1H, s, H-14), 5.42 (2H, s, H-17), 5.29 (2H, s, H-5), 1.86 (2H, q, J=7.2 Hz, H-19), 0.88 (3H, t, J=7.2 Hz, H-18); 13C NMR (DMSO-d6, 150 MHz) δ 173.6 (C, C-21), 157.6 (C, C-22), 153.5 (C, C-2), 150.1 (C, C-15), 148.1 (C, C-13), 145.9 (C, C-3), 131.5 (CH, C-7), 130.6 (C, C-6), 130.2 (CH, C-11), 129.2 (CH, C-12), 128.7 (CH, C-9), 128.1 (C, C-8), 127.8 (CH, C-10), 120.1 (C, C-16), 96.9 (CH, C-14), 73.6 (C, C-20), 65.6 (CH2, C-17), 50.8 (CH2, C-5), 30.2 (CH2, C-19), 7.8 (CH3, C-18).

Trifolin (kaempferol-3-O-β-D-galactopyranoside) (Compound 2) was obtained as a yellowish amorphous solid: [α]D25-78.6° (c 0.1, DMSO); Rf 0.51 (silica gel, solvent B) and 0.60 (reversed-phase C18 silica gel, solvent D); UV (EtOH) λmax (log ε) 265 (4.21), 355 (3.52) nm; IR νmax (KBr) 3356, 3000, 1651, 1610, 1573 cm-1; 1H NMR (DMSO-d6, 600 MHz) δ 12.6 (1H, s, OH-5), 8.03 (2H, d, J=9.0 Hz, H-2′, H-6′), 6.87 (2H, d, J=9.0 Hz, H-3′, H-540 ), 6.43 (1H, d, J=2.5 Hz, H-8), 6.20 (1H, d, J=2.5 Hz, H-6), 5.46 (1H, d, J=7.5 Hz, H-1″), 3.58 (1H, m, H-6″a), 3.56 (1H, m, H-6″b), 3.38 (1H, m, H-5″), 3.32 (1H, m, H-2″), 3.22 (1H, m, H-3″), 3.12 (1H, m, H-4′); 13C NMR (DMSO-d6, 150 MHz) δ 177.5 (C, C-4), 164.1 (C, C-7), 161.2 (C, C-5), 159.9 (C, C-4′), 156.4 (C, C-9), 156.2 (C, C-2), 133.2 (C, C-3), 130.2 (CH, C-2′, C-6′), 115.7 (CH, C-3′, C-5′), 114.5 (C, C-1′), 104.0 (C, C-10), 101.5 (CH, C-1″), 99.1 (CH, C-6), 94.0 (CH, C-8), 77.0 (CH, C-5″), 74.8 (CH, C-3″), 73.6 (CH, C-2″), 70.5 (CH, C-4″), 61.9 (CH2, C-6″).

Hyperoside (quercetin-3-O-β-D-galactopyranoside) (Compound 3) was obtained as a yellowish amorphous solid: [α]D25-81.8° (c 0.1, DMSO); Rf 0.34 (silica gel, solvent B) and 0.75 (reversed-phase C18 silica gel, solvent D); UV (EtOH) λmax (log ε) 256 (4.37), 356 (3.58) nm; IR νmax (KBr) 3360, 3031, 1652, 1615, 1569 cm−1; 1H NMR (DMSO-d6, 600 MHz) δ 12.6 (1H, s, OH-5), 7.66 (1H, d, J=7.8 Hz, H-6′), 7.53 (1H, br s, H-2′), 6.80 (1H, d, J=7.8 Hz, H-5′), 6.40 (1H, d, J=2.0 Hz, H-8), 6.20 (1H, d, J=2.0 Hz, H-6), 5.37 (1H, d, J=7.2 Hz, H-1″), 3.65 (1H, m, H-6″a), 3.57 (1H, m, H-6″b), 3.44 (1H, m, H-5″), 3.36 (1H, m, H-2″), 3.33 (1H, m, H-3″), 3.16 (1H, m, H-4″); 13C NMR 13C NMR (DMSO-d6, 150 MHz) δ 177.8 (C, C-4), 164.3 (C, C-7), 161.3 (C, C-5), 156.5 (C, C-9), 156.3 (C, C-2), 148.7 (C, C-4′), 144.5 (C, C-3′), 133.8 (C, C-3), 122.0 (CH, C-6′), 121.5 (C, C-1′), 116.0 (CH, C-2′), 115.1 (CH, C-5′), 103.9 (C, C-10), 101.3 (CH, C-1″), 98.9 (CH, C-6), 94.0 (CH, C-8), 77.3 (CH, C-5″), 74.6 (CH, C-3″), 73.5 (CH, C-2″), 70.3 (CH, C-4″), 61.5 (CH2, C-6″).

B. Fungal Inhibition Experimentation.

Alternaria alternata, Epicoccum nigrum, Pestalotia guepinii, Drechslera sp., and Fusarium avenaceum were isolated from infected leaves and roots of C. acuminata. The strains were cultured and maintained on potato dextrose agar (PDA) medium.

CPT, trifolin, and hyperoside (isolated from Camptotheca as above) were tested for their ability to inhibit these fungi, as compard with two classical fungicides, Bravo (active ingredient: chlorothalonil) and Maneb (active ingredient: manganous ethylenebis [dithiocarbamate]), as references. The concentrations of the conventional fungicides were those recommended by the manufacturers (Bravo: 10,000 μg/mL; Maneb: 3,000 μg/mL).

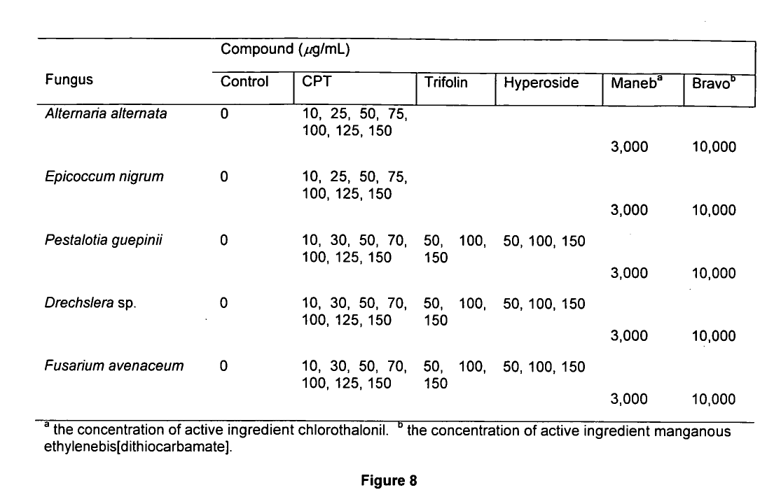

In addition to a negative control (0) and two fungicides as positive controls for each of the five isolated pathogens, seven levels of CPT were tested with each of the fungi and three levels of trifolin and hyperoside were tested with P. guepinii, Drechslera sp. and F. avenaceum, respectively (see FIG. 8).

Trifolin and hyperoside treatments were applied at concentrations of 50, 100, and 150 μg/mL, respectively. For all cultures, final concentrations were made in molten (50° C.) potato dextrose agar (Difco), and 10 mL aliquots were poured into Petri dishes (85 mm in diameter). Within 24 hours after pouring, each of the plates was inoculated with one of the five fungi. One 5×5 mm mycelial plug was cut from the actively growing front of a 2 week old colony, then placed with the inoculum side down in the center of each treatment plate. The cultures were incubated at 24° C. For all experiments, five replicate plates were inoculated for each treatment.

Mycelial growth on each plate was observed daily and recorded on a transparent film for the first two weeks, then recorded on the 16^{th}, 20^{th}, 23^{rd}, and 28^{th} days. Colony radii were measured along four vertical radial directions. The mean of the four measurements was calculated as the growth rate on each plate. Mean and standard error were calculated from the five replicates of each treatment. For each of the fungi, values of EC₅₀ (effective concentration that caused 50% inhibition of mycelial growth) and MIC (the minimum inhibitory concentration) of each compound were estimated.

C. Findings.

1. Antifungal Activity against Alternaria alternata.

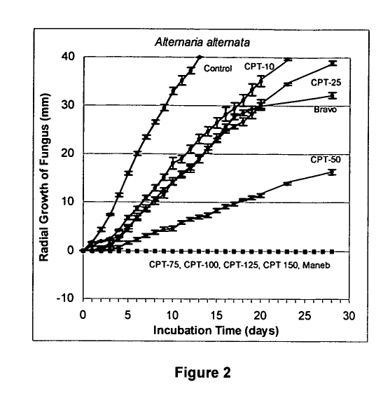

CPT significantly inhibited Alternaria growth at the lowest treatment concentration of 10 μg/mL (CPT-10) (p<0.001). Colonies exposed to CPT-10 were inhibited by 41-66%. It took 23 days for mycelium under the CPT-10 treatment to completely cover the agar surface, as compared to 13 days under control treatment. CPT-25 (CPT at the concentration of 25 μg/mL) was similar to Bravo in its ability to inhibit A. alternata (FIG. 2). Colonies in both treatments started to grow on the second day of the experiment and their radii were always within about one millimeter of one another. CPT-25 colony expansion was reduced by 215% (28 days to cover the agar surface vs. 13 days for control). On day 13, colonies in the CPT-25 treatment were 52.8% smaller than controls. Thus, it is estimated that the EC₅₀ of CPT for A. alternata is less than 25 μg/mL. The CPT-50 treatment was able to inhibit fungal growth by more than 180%. The fungus was totally controlled by CPT at concentrations of 75 μg/mL (CPT-75) and above, and by the fungicide Maneb.

2. Antifungal Activity against Epicoccum nigrum.

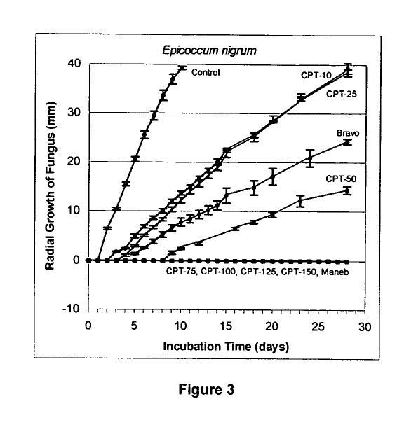

Epicoccum nigrum grew faster than A. alternata under control conditions in the experiment, with colonies covering the agar surface in 10 days (FIG. 3). However, this fungus was more strongly inhibited by CPT and fungicide than A. alternata. CPT at low levels (10 μg/mL and 25 μg/mL) delayed mycelial growth of E. nigrum by 280% (28 days to cover agar surface vs. 10 days for control). CPT-10 and CPT-25 treatments were not significantly different in their ability to inhibit E. nigrum. On day 10, colonies in the CPT-10 treatment were 65% smaller than controls. Thus, the EC₅₀ of CPT for E. nigrum is estimated to be less than 10 μg/mL. Similarly to results with A. alternata, CPT-50 (CPT at the concentration of 50 μg/mL) inhibited growth of E. nigrum by more than 90% while CPT-75 (CPT at the concentration of 75 μg/mL) and higher concentrations as well as Maneb totally inhibited growth. Bravo treatment was slightly superior to CPT-10 and CPT-25. Colonies exposed to Bravo did not start to grow until the fifth day; by day 15 they had radii of 13 mm compared to 20 mm in CPT-25 treatment. The CPT-50 treatment was superior to Bravo. Under this treatment, growth did not begin until the 8^{th} day of the experiment. On day 20, colony radii measured 19 mm under Bravo treatment but only 8 mm when exposed to CPT-50.

3. Antifungal Activity against Pestalotia guepinii.

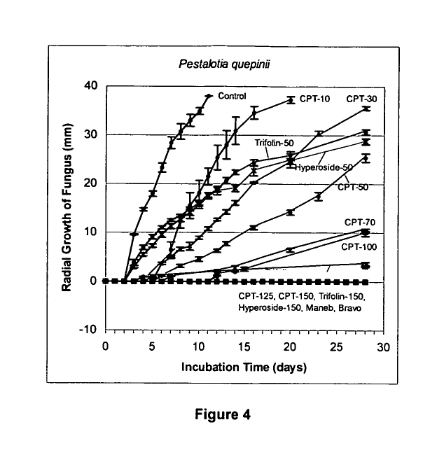

Pestalotia guepinii showed a similar growth pattern to E. nigrum under control conditions (FIG. 4). CPT-10 reduced mycelial growth by 43.5% on the 11^{th} day when the fungus under control treatment had covered the agar surface. Colonies exposed to CPT-10 treatment did not reach the petri dish margins until day 20. Thus, it is estimated that the EC₅₀ of CPT for P. guepinii is approximately 10 μg/mL. However, CPT totally inhibited growth only at levels of 125 μg/mL and above. Both fungicides also successfully controlled P. guepinii. Trifolin and hyperoside were similar in their ability to inhibit P. guepinii. On day 11, colonies exposed to either trifolin-50 or hyperoside-50 were inhibited by 53.4% and 53.8%, respectively. The EC₅₀ of both flavonoids for P. guepinii is estimated to be approximately 50 μg/mL. However, as concentrations increased to 100 μg/mL, the flavonoids were more effective in inhibition of P. guepinii than CPT; MICs of both trifolin and hyperoside for P. guepinii are most likely below 125 μg/mL, the level at which CPT successfully controlled the fungus.

4. Antifungal Activity against Drechslera sp.

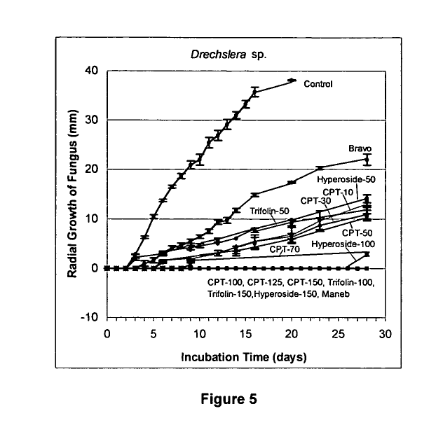

Drechslera sp. grew more slowly than A. alternata, E. nigrum, and P. guepinii under control conditions but was also more sensitive to CPT, flavonoids, and fungicides than the other fungi tested (FIG. 5). CPT at all experimental levels showed greater inhibition rates than Bravo. This fungicide reduced mycelial growth by 54.4% on day 20, when control mycelium completely covered the agar surface. Thus, the EC₅₀ of CPT for Drechslera is less than 10 μg/mL. However, CPT only completely inhibited fungal growth at the concentrations of 100 μg/mL and higher. Trifolin-50 and hyperoside-50 (trifolin and hyperoside at the concentrations of 50 μg/mL) were similar in their ability to inhibit Drechslera. On day 20, colonies exposed to either trifolin-50 or hyperoside-50 were inhibited by 76.1% and 74.3%, respectively. Thus, the EC₅₀ values of both flavonoids against Drechslera are less than 50 μg/mL. Hyperoside-100 (hyperoside at the concentration of 100 μg/mL) inhibited fungal growth successfully with little growth by day 28, while trifolin-100 (trifolin at the concentration of 100 μg/mL) totally controlled the fungus over the course of the entire experiment. CPT at the concentrations of 100 μg/mL and above, trifolin at the concentrations of 100 and 150 μg/mL, hyperoside at the concentrations of 150 μg/mL, and Maneb completely inhibited growth of Drechslera.

5. Antifungal Activity against Fusarium avenaceum.

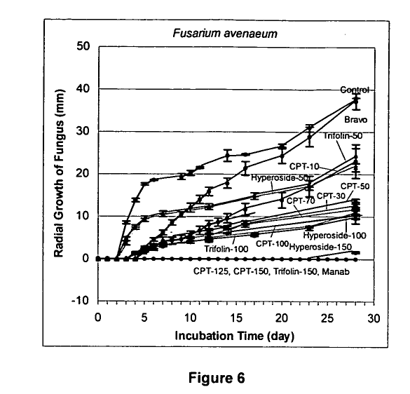

Fusarium avenaceum exhibited the slowest growth rate of all experimental fungi under control conditions, but was somewhat less sensitive to CPT, flavonoids, and fungicides (FIG. 6). Bravo showed effective inhibition of mycelial growth during the first several days of the experiment but was less effective in the later stages. On day 28, mycelium with Bravo treatment completely covered the agar surface similar to the control colonies. CPT-10 was much more effective than Bravo, with 70-80% inhibition of mycelial growth during the first several days of the experiment and approximately 40% inhibition in the later stages. CPT-30 inhibited the rate of mycelial growth by more than 60%. Thus, the EC₅₀ of CPT for F. avenaceum is estimated to be between 10 and 30 μg/mL.

Higher levels of CPT more effectively inhibited mycelial growth but complete inhibition was not achieved until the concentration of 125 μg/mL. Trifolin and hyperoside exhibited similar inhibition patterns at the level of 100 μg/mL, but trifolin was more effective than hyperoside at the concentration of 50 μg/mL. Trifolin-50 and hyperoside-50 were less effective against F. avenaceum than Bravo and CPT-10 at the beginning of experiment but more effective than Bravo and similar to CPT-10 during the later stages of the experiment. On day 28, trifolin and hyperoside inhibited fungal growth by 35.8% and 31.6%, respectively, at the concentration of 50 μg/mL, and by 74.8% and 72.6%, respectively, at the concentration of 100 μg/mL.

Thus, it is estimated that EC₅₀ values of both flavonoids against F. avenaceum are between 50 and 100 μg/mL. Hyperoside at the concentration of 150 μg/mL completely inhibited fungal growth during the first four weeks, while trifolin at the same level totally controlled the fungus during the entire experiment. CPT at the concentrations of 125 and 150 μg/mL and Maneb also completely inhibited growth of F. avenaceum.

Use of the agents camptothecin, trifolin and/or hyperoside in inhibiting initial fungal infestation, containing existing infestation, or reversing existing infestation can take many forms. These may include foliar sprays, soil drench applications, treatment of plant growth medium (before or after plants are resident therein), and, in the case of trees, injection into trunks or branches. The method of the present invention is not limited to any particular form, nor need it be in terms of novelty or obviousness, in view of the completely unanticipated use of the cited compounds in the context of anti-fungal measures, despite the compelling need therefore.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention.

It is, therefore, contemplated that the appended claims will cover such modifications that fall within the scope of the invention.

I claim:

1. A method for preventing or inhibiting the growth of fungal pathogens in plants comprising the steps of:
selecting one or more plant extracts from a group consisting of camptothecin, trifolin and hyperoside; and
applying said one or more plant extracts to a plant.

2. The method of claim 1 further comprising the step of, before said selecting one or more plant extracts, of extracting said one or more extracts from one or more plants.

3. The method of claim 2 wherein said one or more plants comprises plants selected from a groups consisting of:
A. Plants from Camptotheca (Nyssaceae), comprising Camptotheca acuminata Decaisne, Camptotheca acuminata var. tenuifolia Fang et Song, Camptotheca acuminata var. rotundifolia Yang et Duan, Camptotheca yunnanensis Dode, Camptotheca lowreyana Li, Camptotheca lowreyana Li ‘Katie’, Camptotheca lowreyana Li ‘Hicksii’;
B. Ervatamia (Apocynaceae);
C. Nothapodytes (Mappia) (Olacaceae);
D. Ophiorrhiza (Rubiaceae);
E. Merrilliodendron (Icacinaceae);
F. Mostuea (Loganiaceae); and
G. Pyrenacantha (Icacinaceae).

4. The method of claim 2 wherein said one or more plants is the member of the Nyssaceae family known as the Camptotheca acuminata tree.

5. A method for preventing or inhibiting the growth of fungal pathogens in plants comprising the steps of:
selecting a first measure of trifolin; and
applying said first measure of trifolin to a plant.

6. The method of claim 5 further comprising the step of, before said selecting said first measure of trifolin, of extracting said trifolin from one or more plants.

7. A method for preventing or inhibiting the growth of fungal pathogens in plants comprising the steps of:
selecting a first measure of hyperoside; and
applying said first measure of hyperoside to a plant.

8. The method of claim 7 further comprising the step of, before said selecting said first measure of hyperoside, of extracting said hyperoside from one or more plants.

9. A method for preventing or inhibiting the growth of fungal pathogens in plants comprising the steps of:
selecting a first measure of camptothecin; and
applying said first measure of camptothecin to a plant.

10. The method of claim 9 further comprising the step of, before said selecting said first measure of camptothecin, of extracting said camptothecin from one or more plants selected from a group consisting of:
A. Plants from Camptotheca (Nyssaceae), comprising Camptotheca acuminata Decaisne, Camptotheca acuminata var. tenuifolia Fang et Song, Camptotheca acuminata var. rotundifolia Yang et Duan, Camptotheca yunnanensis Dode, Camptotheca lowreyana Li, Camptotheca lowreyana Li ‘Katie’, Camptotheca lowreyana Li ‘Hicksii’;
B. Ervatamia (Apocynaceae);
C. Nothapodytes (Mappia) (Olacaceae);
D. Ophiorrhiza (Rubiaceae);
E. Merrilliodendron (Icacinaceae);
F. Mostuea (Loganiaceae); and
G. Pyrenacantha (Icacinaceae).

11. A method for preventing or inhibiting the growth of fungal pathogens in plants comprising the steps of:
selecting one or more plant extracts from a group consisting of camptothecin trifolin and hyperoside; and
applying said one or more plant extracts to a plant growth medium.

12. The method of claim 11 further comprising the step of, before said selecting one or more plant extracts, of extracting said one or more extracts from one or more plants.

13. A method for preventing or inhibiting the growth of fungal pathogens in plants comprising the steps of:
selecting a first measure of trifolin; and
applying said first measure of trifolin to a plant growth medium.

14. The method of claim 13 further comprising the step of, before said selecting said first measure of trifolin, of extracting said trifolin from one or more plants.

15. A method for preventing or inhibiting the growth of fungal pathogens in plants comprising the steps of:
selecting a first measure of hyperoside; and
applying said first measure of hyperoside to a plant growth medium.

16. The method of claim 15 further comprising the step of, before said selecting said first measure of hyperoside, of extracting said hyperoside from one or more plants.

17. A method for preventing or inhibiting the growth of fungal pathogens in plants comprising the steps of:
selecting a first measure of camptothecin; and
applying said first measure of camptothecin to a plant growth medium.

18. The method of claim 17 further comprising the step of, before said selecting said first measure of camptothecin, of extracting said camptothecin from one or more plants.

19. The method of claim 18 wherein said one or more plants comprises plants selected from a groups consisting of:
A. Plants from Camptotheca (Nyssaceae), comprising Camptotheca acuminata Decaisne, Camptotheca acuminata var. tenuifolia Fang et Song, Camptotheca acuminata var. rotundifolia Yang et Duan, Camptotheca yunnanensis Dode, Camptotheca lowreyana Li, Camptotheca lowreyana Li ‘Katie’, Camptotheca lowreyana Li ‘Hicksii’;
B. Ervatamia (Apocynaceae);
C. Nothapodytes (Mappia) (Olacaceae);
D. Ophiorrhiza (Rubiaceae);
E. Merrilliodendron (Icacinaceae);
F. Mostuea (Loganiaceae); and
G. Pyrenacantha (Icacinaceae).

20. The method of claim 18 wherein said one or more plants is the member of the Nyssaceae family known as the Camptotheca acuminata tree.

21. A method for preventing or inhibiting the growth of molds in a substrate comprising the steps of:
selecting one or more plant extracts from a group consisting of camptothecin, trifolin, and hyperoside; and
applying said one or more plant extracts to said substrate.

22. The method of claim 21 further comprising the step of, before said selecting one or more plant extracts, of extracting said one or more extracts from one or more plants.

23. The method of claim 22 wherein said one or more plants comprises plants selected from a groups consisting of:
A. Plants from Camptotheca (Nyssaceae), comprising Camptotheca acuminata Decaisne, Camptotheca acuminata var. tenuifolia Fang et Song, Camptotheca acuminata var. rotundifolia Yang et Duan, Camptotheca yunnanensis Dode, Camptotheca lowreyana Li, Camptotheca lowreyana Li ‘Katie’, Camptotheca lowreyana Li ‘Hicksii’;
B. Ervatamia (Apocynaceae);
C. Nothapodytes (Mappia) (Olacaceae);
D. Ophiorrhiza (Rubiaceae);
E. Merrilliodendron (Icacinaceae);
F. Mostuea (Loganiaceae); and
G. Pyrenacantha (Icacinaceae).

24. The method of claim 22 wherein said member of the Nyssaceae family is the Camptotheca acuminata tree.
